(19) United States
(12) Patent Application Publication
(10) Pub. No.: US 2025/0110451 A1
(43) Pub. Date: Apr. 3, 2025

(54) MONITORING AT LEAST ONE MACHINE

(71) Applicant: SICK AG, Waldkirch (DE)

(72) Inventors: Christoph HOFMANN, Waldkirch (DE); Alfred AROCKIARAJ, Waldkirch (DE)

(21) Appl. No.: 18/899,710

(22) Filed: Sep. 27, 2024

(30) Foreign Application Priority Data
Sep. 28, 2023 (EP) 23200689.0

(51) Int. Cl. G05B 9/02

(52) U.S. Cl. CPC G05B 9/02

(57) ABSTRACT

A method of safeguarding at least one machine (12) that is monitored by at least one sensor (14) that generates sensor data with respect to the machine (12) is provided, wherein movements of a machine model of the machine (12) are carried out in a simulation and synthetic sensor data of a sensor model of the sensor (14) are generated, and wherein a plurality of safety functions (72) are performed in the simulation in which an evaluation is made by safety related evaluation of the simulation whether a hazardous situation is present to output a safety signal to the machine (12) to trigger a safety response in the case of a hazardous situation, The safety functions (72) are here each individually implemented per se in a container.

The invention relates to a method of monitoring at least one machine and to a corresponding safety device.

Safety engineering deals with personal protection and with the avoidance of accidents with machines. The machine or its environment is monitored by one or more sensors to switch it to a safe state in good time when there is impending danger. A typical conventional safety engineering solution monitors a protected field that may not be entered by operators during the operation of the machine by the at least one sensor, for instance by means of a laser scanner. If the sensor recognizes an unauthorized intrusion into the protected field, for instance a leg of an operator, it triggers an emergency stop of the machine. There are alternative protection concepts such as so-called speed and separation monitoring in which the distances and speeds of the detected objects in the environment are evaluated and a response is made in a hazardous case.

Particular reliability is required in safety engineering and high safety demands therefore have to be satisfied, for example the standard EN13849 for safety of machinery and the machinery standard EN61496 for electrosensitive protective equipment (ESPE). Some typical measures for this purpose are a secure electronic evaluation by redundant, diverse electronics or different functional monitoring processes, for instance the monitoring of the contamination of optical components, including a front screen. Somewhat more generally, well-defined error control measures have to be demonstrated so that possible safety-critical errors along the signal chain from the sensor via the evaluation up to the initiation of the safety engineering response can be avoided or controlled.

Due to the high demands on the hardware and software in safety engineering, primarily monolithic architectures have been used to date using specifically developed hardware that provides for redundancies and a functional monitoring by multi-channel capability and test possibilities. Proof of correct algorithms is accordingly documented, for instance in accordance with IEC TS 62998, IEC-61508-3, and the development process of the software is subject to permanent strict tests and checks. An example for this is a safety laser scanner such as is known, for example, for the first time from DE 43 40 756 A1 and whose main features have used in a widespread manner up to now. The entire evaluation function, including the time of flight measurement for the distance determination and the object detection in configured protected fields, is integrated there. The result is a fully evaluated binary securing signal at a two-channel output (OSSD, output signal switching device) of the laser scanner that stops the machine in the event of an intrusion into the protected field. Even though this concept has proven itself, it remains inflexible since changes are practically only possible by a new development of a follow-up model of the laser scanner.

In some conventional safety applications, at least some of the evaluation is outsourced from the sensor into a programmable logic controller (PLC). However, particular safety controllers are required for this purpose that themselves have multi-channel structures and the like for fault avoidance and fault detection. They are therefore expensive and provide comparatively little memory capacity and processing capacity that are, for example, completely overwhelmed by 3D image processing. In another respect, standard controllers or PLCs can only be programmed with certain languages with in part a very limited language area. Even relatively simple functional blocks require substantial development effort and runtime resources so that their implementation in a standard controller can hardly be realized with somewhat more complex applications, particularly under safety measures such as redundancies.

There have long been very more flexible architectures outside safety engineering. The monolithic approach has there long given way in a number of steps to more modern concepts. The earlier traditional deployment with fixed hardware on which an operating system coordinates the individual applications admittedly is still justified in stand-alone devices, but has no longer been satisfactory in a networked world. The basic idea in the further development was the inclusion of additional layers that are further and further abstract from the specific hardware.

The so-called virtual machines where the additional layer is called a hypervisor or a virtual machine monitor are a first step. Such approaches have also been tentatively pursued in safety engineering in the meantime. EP 3 179 279 B1, for instance, provides a protected environment in a safety sensor to permit the user to allow his own program modules to run on the safety sensor. The program modules are then, however, carefully separated from the safety functionality and do not contribute anything to it.

A further abstraction is based on so-called containers (container virtualization, containering). A container is so-to-say a small virtual capsule for a software application that provides a complete environment for its running including memory areas, libraries, and other dependences. The associated abstracting layer or runtime environment is called a container runtime. The software application can thus be developed independently of the hardware, that can be practically any hardware,, on which it later runs. Container technology thus permits applications to be run in an isolated and reproducible manner in practically any environments in a slimmed down, transferable manner. Containers are frequently implemented with the aid of Docker, Podman or LXC (Linux Containers) are also known.

In a modern IoT (internet of things, industrial internet of things) architecture, a plurality of containers having the most varied software applications are combined. These containers have to be suitably coordinated, which is known as orchestration in this connection, and for which a so-called orchestration layer is added as a further abstraction. A container orchestration platform is a tool to automate the deployment, management, scaling, and networking of containers. Thanks to orchestration, developers can think on the level of the application instead of a laborious individual management of containers. There are further tools by which the desired system states can be specified on a higher, more understandable level. Very large projects with many thousands of containers, and even more, can thus also be implemented. Kubernetes is increasingly establishing itself for container orchestration. Alternatives such as Docker Swarm as an expansion of Docker and OpenShift, Rancher, Google Container Engine (GKE), or Amazon Elastic Kubernetes Service (Amazon EKS) can additionally be named.

The use of such modern, abstracting architectures in safety engineering has previously failed due to the high hurdles of the safety standards and the correspondingly conservative approach in the application field of functional safety. Container technologies are definitely generally pursued in the industrial environment and there for plans, for example in the automotive industry, for the use of Kubernetes architecture; and the German air force is also pursuing such approaches. However, none of this is directed to functional safety and so does not solve the problems named.

A high availability is admittedly also desired in a customary IoT world, but this form of fail-safeness is by no means comparable to what the safety standards require. Edge or cloud applications have therefore been inconceivable for safety satisfying the standards for a safety engineer. It contradicts the widespread concept of providing reproducible conditions and preparing for all the possibilities of a malfunction that are imaginable under these conditions. An extensive abstraction provides additional uncertainty that has previously appeared incompatible with the safety demands.

A further trend is appearing in industry, namely virtualization. At this point, it is not abstraction in the sense of hardware independence that is meant as with containers or orchestration, but rather the transfer of real scenes into the virtual world. In particular simulations of machines, sensors, and whole industrial plant are provided, at times under the headword of a digital twin. There have been huge advances here, particularly more recently, that permit a very realistic, dynamic simulation with respect to the runtime. The gap between the simulation and reality (the reality gap) is closing more and more, for example, using modern physics engines. A physics engine is able to simulate physical processes, for instance using models for the dynamics of rigid or soft bodies including collision recognition or for fluid dynamics.

There are some software systems (simulation and virtualization framework) that support a transfer of the real world into the simulated world and that are therefore called simulation environments here. Despite its name, ROS (robot operating system) is rather a collection of open source libraries and open source tools and not an operating system, but rather middleware that communicates with deployed sensors and actuators (ROS nodes). There are a number of additional functions such as rviz for three-dimensional views of robots and their environment as well as sensor data, ROS Gazebo as a physics engine, or MoveIt for path planning. Further known simulation environments using powerful physics engines are Unity, MuKoCo, or Nvidias Omniverse. The latter integrates powerful AI technologies and has numerous expansions and plug-ins. The simulation of persons and their movement behaviors are thus in particular also possible.

If, for example, the three simulation environments of ROS, Unity, and Omniverse are compared, Unity and Omniverse have no recording functions for a later or offline further processing and no driver support for older hardware. In turn, ROS, at least on its own, has no powerful physics engine together with the generation of realistic views (rendering) comparable with Unity or Omniverse. A monitoring or a restart in the event of a failure is not possible with any of said simulation environments. Conventional virtualization or simulation environments are not safe; they do not satisfy the safety standards; and this may be one reason why virtualization still plays as good as no role in very conservative safety technology.

In stateful communication, a protocol is used that contains the context and thus associates messages of earlier queries and so allows reproducibility. To be able to handle large data volumes in real time, a scalable server cluster interacts. The processing of millions of messages per second and the storage of petabytes of data thus become possible, with redundancies protecting against delays and data loss. Apache Kafka is a known communication system of this kind that is highly scalable, fast, and error-tolerant. RabbitMQ, ActiveMQ, and RedisStreams can also be named here.

EP 4 040 034 A1 presents a safety device and a safety method for monitoring a machine in which the safety functionality can be abstracted from the underlying hardware using said container and orchestration technologies. Logic units are generated, resolved, or assigned to other hardware as required. The yet to be published European patent application bearing the file reference 22216057.4 improves the diagnostic functionality for this by using two kinds of messages, namely state messages and performance messages. However, none of the documents deal with simulation or virtualization in the just explained sense.

It is therefore the object of the invention to provide a more flexible safety concept.

This object is satisfied by a method and by a safety device for monitoring at least one machine in accordance with the respective independent claim. The method is a computer implemented method that runs on practically any desired processing unit. Examples of suitable hardware will be named below. The monitored machine or the machine to be safeguarded should initially be understood generally; it is, for example, a processing machine, a production line, a sorting station, a process unit, a robot, or a vehicle in a large number of variations such as rail-bound or not, guided or driverless, and the like. A very large number of such robots or vehicles can in particular be present such as in an industrial or logistics center. At least one sensor delivers sensor data to the machine, i.e. data on the machine itself, on what it interacts with, or on its environment. The sensor data are at least partially safety relevant; additional non-safety relevant sensor data for automation functions or comfort functions are conceivable. The sensors can be, but do not have to be, safe sensors; safety can only be ensured at a later position.

The at least one machine and the at least one sensor are simulated in a simulation, with in particular data twins being generated for this purpose. This simulation can be understood as a virtualization in the sense explained in the introduction. A machine model performs movements of the machine and a sensor model generates synthetic sensor data. Further simulation components, in particular of persons in the environment of the machine, are possible. A plurality of safety functions are additionally carried out in the simulation. The safety functions evaluate the simulation in a safety related manner, with different aspects of the simulation being assessed depending on the safety function, with the synthetic sensor data or parts thereof preferably being evaluated. Said safety functions form part of the simulation and can therefore be called virtual safety functions. The simulation thus becomes a safe virtualization or a safe digital twin.

If it is shown by the safety related evaluation of the safety functions that a hazardous situation is present, a safety signal is output to the machine that triggers a safety response there. The machine therefore eliminates the recognized hazard by a suitable measure. Depending on the situation, this is achieved, for example, by a slowing down, a special working mode of the machine, for example with a restricted freedom of movement or variety of movements, an evasion, or a stopping. Care must be taken that the safety signal is output to the real machine. The safety response is preferably also triggered in the machine model to keep the simulation consistent. A hazardous situation means that there is an impending accident, for example because a minimum distance between a person and the machine is not observed. What a hazardous situation specifically is, is defined in the safety function. As explained below, the hazardous situation can result from the safety functions alone or in their interaction with an evaluation of the real sensor data.

The invention starts from the basic idea of breaking down the previously monolithic processing of the simulation environments and of atomizing the individual safety functions. The safety functions are each individually implemented per se in a container for this purpose. The safety functions are thus encapsulated or containerized and are released from their rigid, monolithic contexts.

The terms safety or safe are used again and again in this description. They are respectively preferably to be understood in the sense of a safety standard. A safety standard, for example for machine safety, electrosensitive protective equipment, or the avoidance of accidents in personal protection is accordingly satisfied, or, worded a little differently again, safety levels defined by standards, errors up to a safety level defined by standards, consequently respective faults up to a safety level defined in the safety standard or specified in an analog manner thereto are controlled. Some examples of such safety standards have been named in the introduction, where the safety levels are called, for example, protective classes or performance levels. The invention is not restricted to a specific one of these safety standards that may vary in their specific numbering and wording regionally and over time, but not in their basic principles for providing safety.

The invention has the advantage that the safety technology can make use of modern virtualizations. Flexibility is provided by the breaking down of previously monolithic architectures and this additionally results in slimmed down safety functions without taking along unnecessary overhead from the simulation environments that the respective safety function does not need at all. A safe virtualization can now be provided for the first time based on the containers; for example by diagnostic functions or other mechanisms, in particular from EP 4 040 034 A1. Known virtualizations are already very powerful; the simulations already come very close to a ground truth of the real world and this potential is now also opened up for safety engineering. The basic approach in accordance with the invention is already radically different than conventionally in safety engineering. A fixed hardware structure has previously been predefined, typically separately developed for exactly the safety function used, wherein conversely the software functionality is likewise tailored for exactly this hardware structure, and is fixedly implemented and tested there. In contrast, the invention manages with practically any desired hardware that may also change over and over again and that can thus be based on different architectures such as ARM or X86. Heterogeneous hardware is even desired in its diversity for increased safety.

The safety signal is preferably output when a hazardous situation is recognized in the simulation. In this embodiment, the simulation is trusted so much that a hazardous situation recognized there, that is purely virtually, is sufficient to intervene in the real world. This does not yet necessarily mean that the simulation is the only means for safeguarding. Erroneous decisions from the simulation would, however, at least impair the availability because a safety response of the machine, and thus a loss of productivity, is unnecessarily triggered.

The sensor data of the sensor are preferably evaluated by at least one real safety function, with the safety signal being output when a safety function of the simulation and the real safety function produce inconsistent results. The real safety function is called such because it does not evaluate synthetic sensor data, but rather real sensor data. The previously named safety functions belong in the virtualization or simulation and could accordingly also be called virtual safety functions. A two-channel structure is established by means of the real safety function; with one channel of the at least one real safety function as previously customary and a second channel of the simulation or the virtual safety functions. There is preferably a virtual safety function imitating the real safety function in addition to the real safety function. All the safety functions are preferably established both in the real world and in the virtual world, even more preferably in a one-to-one relationship. It is then possible to compare directly whether the real and virtual safety functions are in agreement on the evaluation of a hazardous situation or not; an unbroken diverse redundancy is thus provided. The safety signal is output in the case of mutual difference. Differences within a tolerance that does not endanger persons can be accepted without outputting a safety signal, for instance slight positional differences of a machine part or of a person. The at least one real safety function is preferably integrated in an architecture comparable with the virtual safety functions, that is, is likewise containerized or orchestrated such as explained, for example, in EP 4 040 034 A1 or also later in the description. In a summary of this paragraph and of the preceding paragraph, the simulation can contribute to safety in two ways. A hazardous situation is recognized solely virtually or the simulation cannot confirm or plausibilize a real safety function.

A simulation environment is preferably implemented by the respective safety function, preferably in its container. The simulation environment or the virtualization framework is thus also containerized, and indeed preferably only to the extent of the functionality actually required for the respective safety function. This provides a slimmed-down implementation without any huge overhead due to a large number of unused functions of the typically very powerful and extensive safety environment. Examples for a simulation environment are named in the introduction, in particular ROS, Unity, or NVidia Omniverse.

The safety functions are preferably performed in a respective one of a plurality of different simulation environments. There are therefore a plurality of simulation environments and each safety function uses a simulation environment suitable for it. The advantages of different simulation environments, that are complementary to a large extent, can thereby be optimally used. This is particularly preferably combined with the containerization of a safety function together with the simulation environment of the previous paragraph. Every safety function is then implemented in a container together with its suitable simulation environment, and indeed preferably only with those functions of the selected simulation environment that it actually requires.

The safety functions preferably communicates over a stateful message system (stateful communication). This makes it possible to understand and secure the communication, and, in the case of errors, to start again from where the error occurred. Suitable implementations for the message system such as Apache Kafka have been named by way of example in the introduction.

The functions for communication over the stateful communication system are preferably implemented by the respective safety function in its container. The safety functions are thus able to take part in the communication required for them in an offset, independent manner and all the monitoring mechanisms for the exchanged messages can engage.

The containers with the safety functions are preferably managed in a performance environment with at least one computing node by a container orchestration system. The mechanisms presented for real safety functions in EP 4 040 034 A1 thus also become available in the simulation or virtualization. The performance environment coordinates or orchestrates the containers with the safety functions. There are at least two abstraction layers, on the one hand a respective container layer (container runtime) of the containers and, on the other hand, an orchestration layer of the performance environment disposed thereabove. This in particular enables load balancing so that latencies between the simulation and reality can in particular be kept negligibly low.

A distinction must be made here between the functional term of the performance environment and the actual hardware. The latter, that is the structural element, can be called a processing unit for distinguishing purposes. The processing unit comprises at least one computing node. It is a digital computing device or a hardware node or a part thereof that provides processing and memory capacities for executing a software function block. However, not every computing node necessarily has to be a separate hardware module; a plurality of computing nodes can, for example, be implemented on the same device by using multiprocessors and conversely a computing node can also bundle different hardware resources.

The containers with their safety functions can in turn be called logic units. There can be further logic units in the performance environment that perform diagnostics in the safety context, but also are also responsible for further diagnostics, automation work, or other work, outside of safety. The performance environment is preferably configured to produce and resolve logic units and to assign them to a node or to move them between nodes. This is preferably not only done once, but also dynamically during operation and it very explicitly also relates to the safety related logic units and thus equally to the containers of the safety functions. The link between the hardware and the evaluation is thus fluid while maintaining functional safety. Conventionally, in contrast, all the safety functions are implemented fixedly and unchangeably on dedicated hardware. A change, where producible at all without conversion or a new development, would be considered as completely incompatible with the underlying safety concept. This already applies to a one-time implementation and in particular to dynamic changes to the runtime. In contrast, everything has previously always been done with a by all means large effort and a large number of complex individual measures such that the safety function finds a well-defined and unchanged environment at the start and over the total operating time

The performance environment is preferably configured to integrate and/or to exclude computing nodes. Not only the software or the container landscape, but equally the hardware environment may thus vary; the performance environment is able to deal with this and to form new or adapted computing nodes. It is accordingly possible to connect new hardware or to replace hardware, in particular for replacement on a (partial) failure and for upgrading and for providing additional computing and memory resources. The logic units can continue to work on the computing nodes abstracted from the performance environment despite a possibly, also brutally changed hardware configuration.

The implementation of the performance environment preferably takes place in Kubernetes. The performance environment is called a “control plane” there. A master coordinates the routines or the orchestration (orchestration layer). Computing nodes are called nodes in Kubernetes and they have at least one subnode or pod in which the logic units run in respective containers. Kubernetes is already aware of mechanisms by which a check is made whether a logic unit is still working. This check, however, does not satisfy any safety specific demands and is substantially restricted to obtaining a sign of life from time to time and possibly to restart a container. There are no guarantees here as to when the fault is noted and has been remedied again.

The performance environment is preferably implemented on at least one sensor, a programmable logic controller, a machine controller, a processor device in a local network, an edge device and/or in a cloud. The underlying hardware landscape is in other words practically as desired, which is a very big advantage. The performance environment works abstractly with computing nodes; the underlying hardware can have a very heterogeneous composition. Edge or cloud architectures in particular become accessible to the safety engineering without having to dispense with the familiar evaluation hardware of (safe) sensors or controllers in so doing.

At least one containerized diagnostic function preferably monitors the safety functions, with the safety function transmitting state messages and performance messages to the diagnostic function for this purpose and the diagnostic function recognizing a safety related malfunction using states from the state messages in a state monitoring and using a performance routine from the performance messages in a performance monitoring. This diagnosis is initially related to the virtual safety functions, but preferably equally extends to the real safety functions; or at least one further diagnostic function, preferably containerized, can be provided for this purpose. A state and performance monitoring of the safety functions or of their containers is carried out by the diagnostic function. The state or status of the diagnosed safety function transmitted via a state message provides information on its readiness for use and possible limitations or errors. A performance message relates to the performance of the safety function or of the associated service and a performance routine of the performed safety functions or services can be generated therefrom. Together, both kinds of messages or monitoring enable a system diagnosis by which a safety related malfunction can be recognized. In this respect, the diagnostic function does not require either special knowledge as to how or with which algorithm a safety function unit works or what evaluation results it delivers even though both would be possible in a supplementary manner. In the event of an error, the safe function cannot be ensured, preferably with similar consequences of an output of a safety signal or of a safety related response of the machine as above for the event of a hazardous situation according to a safety related evaluation of the simulation.

The at least one sensor is preferably configured as an optoelectronic sensor, in particular a light barrier, light scanner, light grid, laser scanner, FMCW LIDAR, or camera, as an ultrasound sensor, inertia sensor, capacitive sensor, magnetic sensor, inductive sensor, UWB sensor, or as a process parameter sensor, in particular a temperature sensor, throughflow sensor, filling level sensor, or pressure sensor, with in particular a plurality of the same or different sensors being provided. These are some examples for sensors that can deliver relevant sensor data for a safety application. The specific selection of the sensor or sensors depends on the respective safety application. The sensors can already be configured as safety sensors. It is, however, explicitly alternatively provided in accordance with the invention to achieve the safety only subsequently by tests, additional sensor systems or (diverse) redundancy, or multi-channel ability, and the like and to combine non-safe sensors of the same or different sensor principles with one another. A failed sensor would, for example, not deliver any sensor data; this would be reflected in the state and performance messages of the safety function unit responsible for the sensor and would thus be noticed by the diagnostic unit in the status and performance monitoring.

The safety device in accordance with the invention or the safety system comprises at least one machine, at least one sensor, and at least one processing unit. The latter provides computer capacities in any desired hardware. A method in accordance with the invention runs in the processing unit. In this respect, the different described aspects and embodiments are possible with respect to the method and the hardware.

The invention will be explained in more detail in the following also with respect to further features and advantages by way of example with reference to embodiments and to the enclosed drawing. The Figures of the drawing show in:

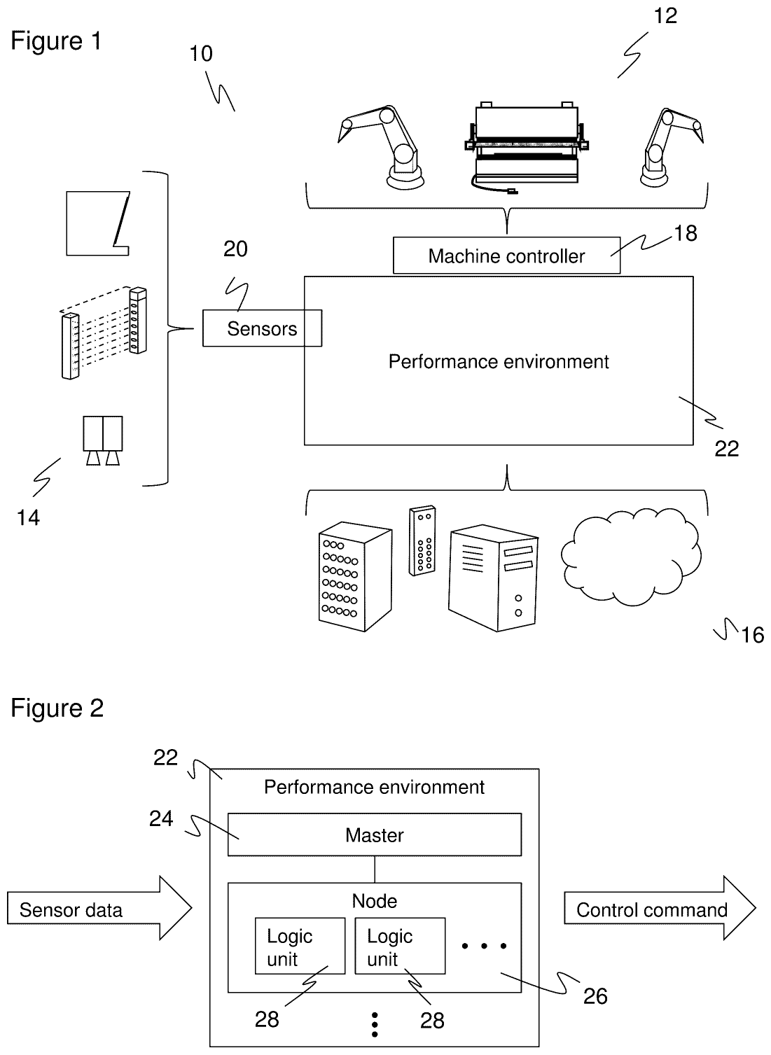

FIG. 1 an overview illustration of a safety device;

FIG. 2 a schematic representation of a performance environment of the safety device;

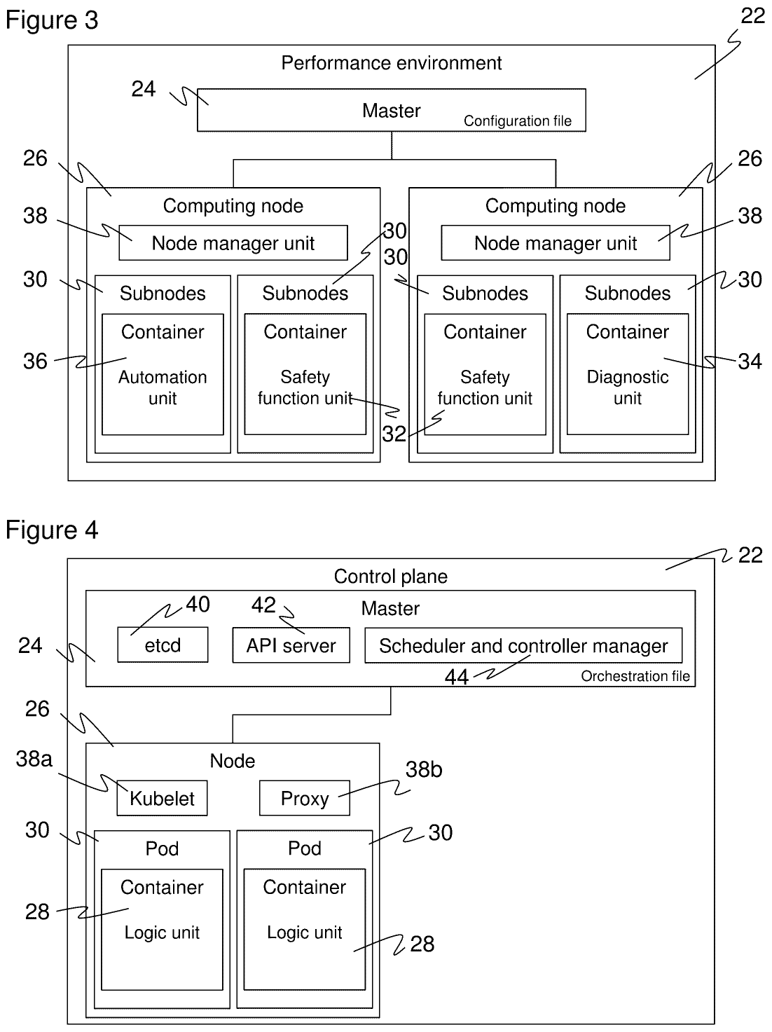

FIG. 3 a schematic representation of a performance environment by way of example with two computing nodes;

FIG. 4 a schematic representation of a special performance environment similar to FIG. 3 using Kubernetes;

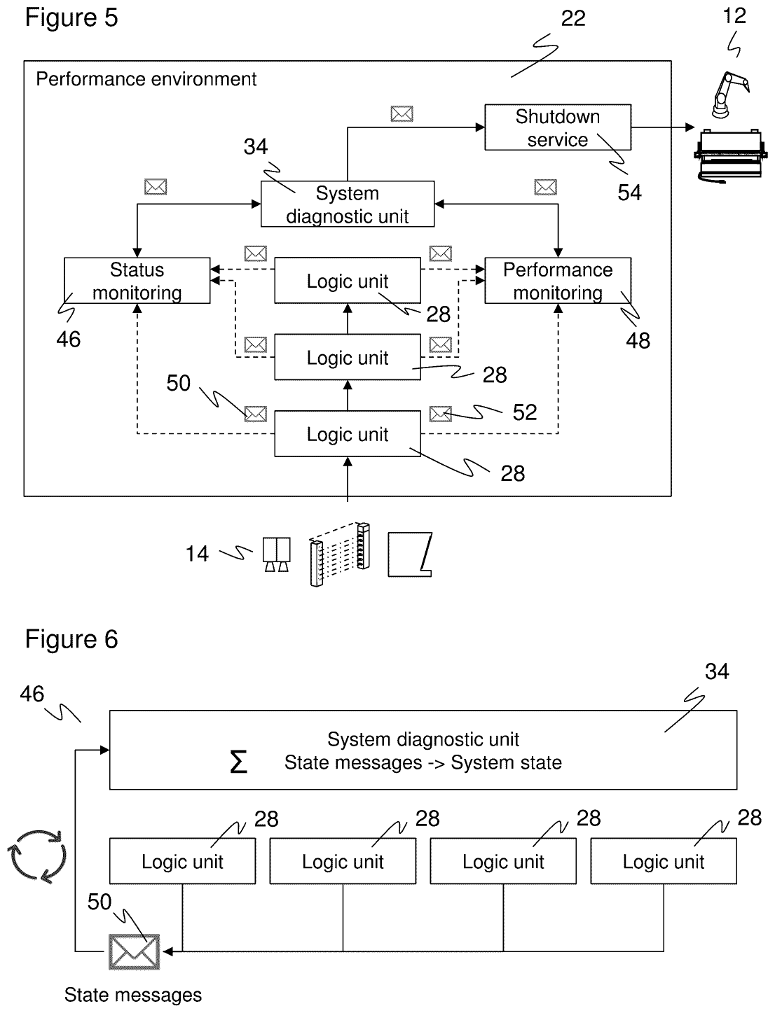

FIG. 5 a schematic representation of the double message flow with state and performance messages to a system diagnostic unit;

FIG. 6 a schematic representation of a state monitoring based on the state messages;

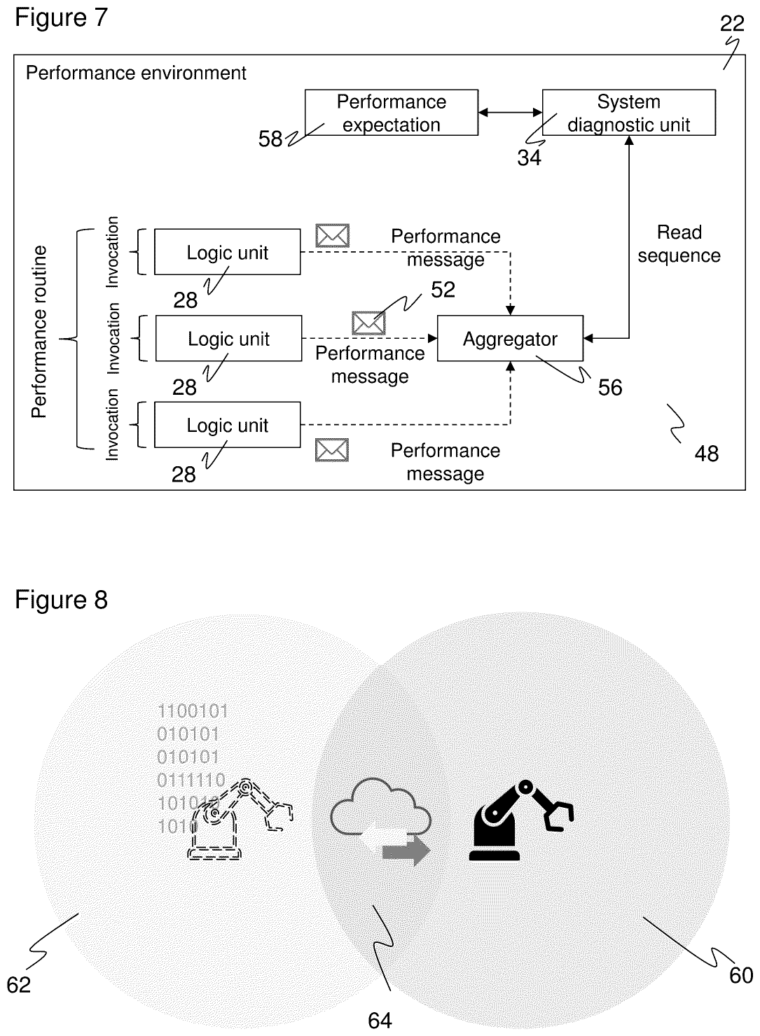

FIG. 7 a schematic representation of a performance monitoring based on the performance messages;

FIG. 8 a comparative illustration of the safety engineering monitoring in the virtual world and the real world;

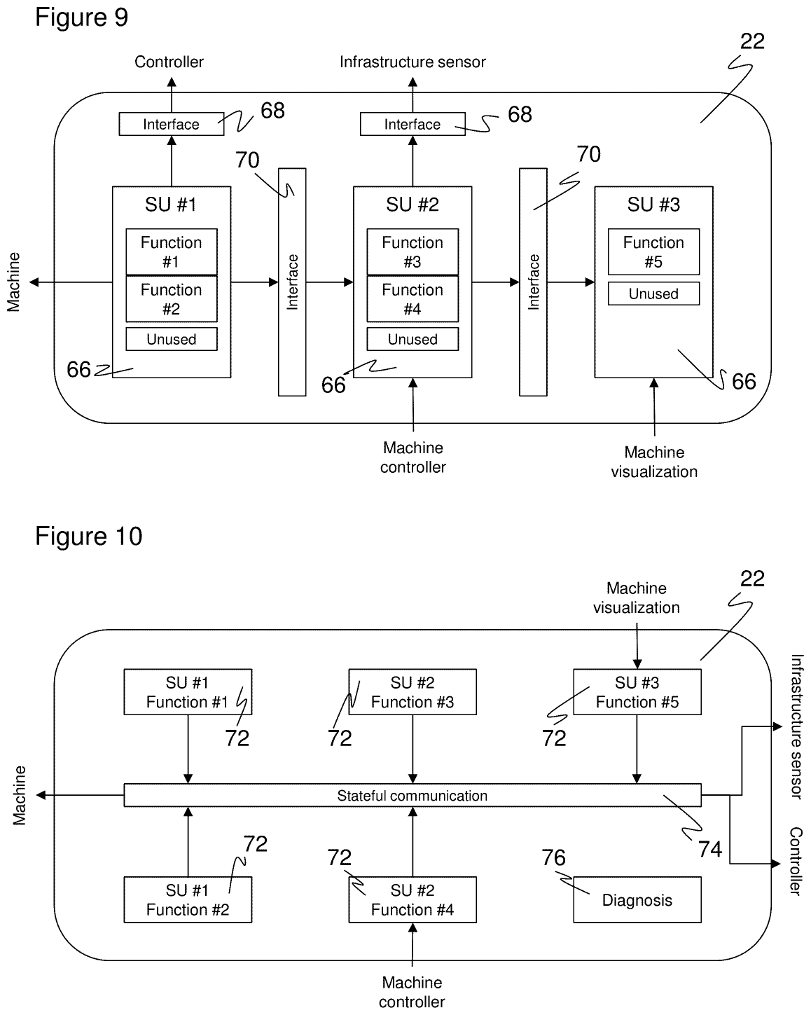

FIG. 9 a representation of a virtualization of at least one machine monitored by at least one sensor with a monolithic implementation of safety functions in respective simulation environments; and

FIG. 10 a representation similar to FIG. 9 of a safe virtualization, now with an implementation of safety functions atomized with the aid of containers.

FIG. 1 shows an overview representation of a safety device 10. The terms safety and safe and unsafe are still to be understood such that corresponding components, transmission paths, and evaluations satisfy or do not satisfy the criteria of safety standards named in the introduction.

The safety device 10 can roughly be divided into three blocks having at least one machine 12 to be monitored, at least one sensor 14 for generating sensor data of the monitored machine 12, and at least one hardware component 16 with computing and memory resources for the control and evaluation functionality for evaluating the sensor data and triggering any safety relevant response of the machine 12. The machine 12, sensor 14, and hardware component 16 are sometimes addressed in the singular and sometimes in the plural in the following, which should explicitly include the respective other variants with only one respective unit 12, 14, 16 or a plurality of such units 12, 14, 16.

Respective examples for the three blocks are shown at the margins. The preferably industrially used machine 12 is, for example, a processing machine, a production line, a sorting plant, a process plant, a robot, or a vehicle that can be rail-bound or not and is in particular driverless (AGC, automated guided cart; AGV, automated guided vehicle; AMR, autonomous mobile robot).

A laser scanner, a light grid, and a stereo camera as representatives of optoelectronic sensors are shown as exemplary sensors 14 which include further sensors such as laser scanners, light barriers, FMCW LIDAR, or cameras having any 2D or 3D detection such as projection processes or time of flight processes. Some examples for sensors 14 that are still not exclusive are UWB sensors, ultrasound sensors, inertia sensors, capacitive, magnetic, or inductive sensors, or process parameter sensors such as temperature sensors, throughflow sensors, filling level sensors, or pressure sensors. These sensors 14 can be present in any desired number and can be combined with one another in any desired manner depending on the safety device 10.

Conceivable hardware components 16 include controllers (PLCs, programmable logic controllers) a computer in a local network, in particular an edge, device or a separate cloud or a cloud operated by others, and very generally any hardware that provides resources for digital data processing.

The three blocks are captured again in the interior of FIG. 1. The machine 12 is preferably connected to the safety device 10 via its machine controller 18, with the machine controller being a robot controller in the case of a robot, a vehicle controller in the case of a vehicle, a process controller in a process plant, and similarly for other machines 12. The sensors 14 combined in the interior as a block 20 not only generate sensor data, but also have an interface, not shown individually, to output the sensor data in a raw or (pre) processed form and as a rule have a separate control and evaluation unit, that is a separate hardware component for digital data processing.

A performance environment 22 is a summarizing term for a processing unit that inter alia performs the data processing of the sensor data to acquire control commands to the machine 13 or other safety relevant and further information. The performance environment 22 is implemented on the hardware components 16 and will be explained in more detail in the following with reference to FIGS. 2 to 4. Which hardware the performance environment 22 is executed on is not fixed in accordance with the invention.

The above list of possible hardware components names some examples that can be combined as desired. The performance environment 22 is furthermore intentionally drawn with an overlap to the machine controller 18 and to the block 20 of the sensors 14 since internal computing and memory resources of the sensors 14 and/or of the machine 12 can be also be used by the performance environment 22, again in any desired combination, including the possibility that there are no additional hardware components 16 outside the machine 12 and the sensors 14. It is assumed in the following that the hardware components 16 provide the computing and memory resources so that an inclusion of internal hardware of the machine 12 and/or sensors 14 is then also meant.

The safety device 10 and in particular the performance environment 22 now provides safety functions and diagnostic functions. A safety function receives the flow of measurement and event information with the sensor data following one another in time and generates corresponding evaluation results, in particular in the form of control signals, for the machine 12. In addition, self-diagnosis information, diagnostic information of a sensor 14, or overview information can be acquired. The diagnostic functions for a monitoring of a safety function, this will be explained in detail below with reference to FIGS. 5 to 7, must be distinguished from this. Unsafe automation functions are conceivable as a further option in addition to these safety related functions or safe automation functions . . . .

The safety device 10 achieves a high availability and robustness with respect to unforeseen internal and external events in that safety functions are performed as services of the hardware components 16. The flexible composition of the hardware components 16 and preferably their networking in the local or non-local network or in a cloud enable a redundancy and a performance elasticity so that interruptions, disturbances, and demand peaks can be dealt with very robustly. The safety device 10 recognizes as soon as defects can no longer be intercepted and thus become safety relevant and then initiates an appropriate response by which the machine 12 is moved into a safe state as required. For this purpose, the machine 12 is, for example, stopped, slowed down, it evades, or works in a non-hazardous mode. It must again be made clear that there are two classes of events that trigger a safety related response: on the one hand, an event that is classified as hazardous and that results from the sensor data, and, on the other hand, the revealing of a safety related defect. Later, with reference to FIGS. 8 to 10, two further triggers emerge, namely an event classified as hazardous within a simulation and a no longer tolerable discrepancy between the previously described safety related evaluation and an associated simulation.

FIG. 2 shows a schematic representation of the performance environment 22. It is ultimately the object of the performance environment 22 to derive a control command from sensor data, in particular a safety signal that triggers a safety related response of the machine 12. The performance environment 22 has a master 24 and at least one computing node 26. The hardware components 16 provided the required computing and memory capacity for the master 24 and computing nodes 26; the performance environment 22 can extend transparently over a plurality of hardware components 16. A computing node 26 is here to be understood abstractly or virtually; there is not necessarily a 1:1 relationship between a computing node 26 and a hardware component 16, but a hardware component 16 can rather provide a plurality of computing nodes 26 or, conversely, a computing node 26 can be deployed over a plurality of hardware components 16. This deployment applies analogously to the master 24.

A computing node 26 has one or more logic units 28. A logic unit 28 is a functional unit that is closed per se, that accepts information, collates it, transforms it, recasts it, or generally processes it into new information and then makes it available to possible consumers for visualization, as a control command, or for further processing, in particular to further logic units 28 or to a machine controller 12. Three kinds of logic units 28 that have already been briefly addressed must primarily be distinguished within the framework of this description, namely safety function units, diagnostic units, and optionally automation units that do not contribute to the safety, but do enable the integration of other automation work in the total application.

The performance environment 22 activates the respective required logic units 28 and provides for their proper operation. For this purpose, it assigns the required resources on the available computing nodes 26 or hardware components 26 to the respective logic units 28 and monitors the activity and the resource requirement of all the logic units 28. The performance environment 22 preferably recognizes when a logic unit 28 is no longer active or when interruptions to the performance environment 22 or the logic unit 28 occurred. It then attempts to reactivate the logic unit 28 and generates a new copy of the logic unit 28 if this is not possible to thus maintain proper operation. However, this is a mechanism that does not satisfy the demands of functional safety and only takes effect if the system diagnosis still to be explained with reference to FIGS. 5 to 7 has not previously uncovered a safety related fault or, for example, during an initialization phase or restart phase in which the machine 12 is anyway still at rest.

Interruptions can be foreseen or unforeseen. Exemplary causes are defects in the infrastructure, that is in the hardware components 16, their operating system, or the network connections; furthermore accidental incorrect operations or manipulations or the complete consumption of the resources of a hardware component 16. If a logic unit 28 cannot process all the required, in particular safety related, information or at least cannot process it fast enough, the performance environment 22 can prepare additional copies of the affected logic unit 28 to thus further ensure the processing of the information. The performance environment 22 in this manner provides that the logic unit 28 produces its function with an expected quality and availability. Such repair and amendment measures are also not any replacement for the system diagnosis still to be described in accordance with the remarks in the previous paragraph.

FIG. 3 again shows a further advantageously fully differentiated performance environment 22 of the safety device 10. The master 24 forms the management and communication center. Configuration information or a configuration file on the logic units 28 present is stored therein so that the master 24 has the required knowledge of the configuration, in particular which logic units 28 there are and should be, on which computing nodes 26 they can be found, and in which time interval they received resources and are invoked. The configuration file is preferably secured via signatures against intentional and unintentional manipulations, for example via blockchain technologies. Safety engineering (safety) here advantageously joins forces with the data integrity ((cyber) security) sine attacks are repulsed or at least recognized in this manner that could result in unforeseeable accident consequences.

The computing nodes 26 advantageously have their own sub-structure, with the now described units also only being able to be present in part. Initially, computing nodes 26 can again be divided into sub-nodes 30. The shown number of two computing nodes 26 each having two subnodes 30 is purely exemplary; there can be as many computing nodes 26 each having any desired number of subnodes 30 as required, with the number of subnodes 30 being able to vary over the computing nodes 26. Logic units 28 are preferably only generated within the subnodes 30, not already on the level of computing nodes 26. Logic units 28 are preferably virtualized, that is containerized, within containers. Each subnode 30 therefore has one or more containers with preferably respectively a logic unit 28. Instead of generic logic units 38, the three already addressed kinds of logic units 28 are shown in FIG. 3, namely two safety function units 32, a diagnostic unit 34, and an automation unit 36. The kind and number of the logic units 28 are only an example, with the system diagnosis still to be explained with reference to FIGS. 5 to 7 preferably managing with only one diagnostic unit 34. The association of logic units 38 with subnodes 30 and computing nodes 26 is wholly independent of the logical structure and cooperation of the logic units 28. No conclusion at all can therefore be drawn on the content cooperation from the arrangement of logic units 28 anyway only shown by way of example; any desired redeployments would be possible with fully the same functionality; the performance environment provides for this.

A node manager unit 38 of the computing node 26 coordinates its subnodes 30 and the logic units 28 assigned to this computing node 26. The node manager unit 38 furthermore communicates with the master 24 and with further computing nodes 26. The management work of the performance environment 22 can be deployed practically as desired on the master 24 and the node manager unit 38; the master can therefore be considered as implemented in a deployed manner. It is, however, advantageous if the master looks after the global work of the performance environment 22 and each node management unit 38 looks after the local work of the respective computing node 26. The master 24 can nevertheless preferably be formed on a plurality of hardware components 16 in a deployed or redundant manner to increase its fail-safeness.

The typical example for the safety function of a safety function unit 32 is the safety related evaluation of sensor data of the sensor 14. Inter alia distance monitoring (specifically speed and separation), passage monitoring, protected field monitoring, or collision avoidance with the aim of an appropriate safety related response of the machine 12 in a hazardous case are possible here. This is the core task of safety engineering, with the most varied paths being possible of distinguishing between a normal situation and a dangerous one in dependence on the sensor 14 and the evaluation process. Suitable safety function units 32 can be programmed for every safety application or group of safety applications or can be selected from a pool of existing safety functional units 32. If the work environment 22 generates a safety function module 32, this then by no way means that the safety function has thus been recreated. Use is rather made of corresponding libraries or dedicated finished programs in a known manner such as by means of data carriers, memories, or a network connection. It is conceivable that a safety function is assembled and/or suitably configured semiautomatically or automatically as from a kit of complete program modules.

A diagnostic unit 34 can be understood in the sense of EP 4 040 034 A1 named in the introduction and can act as a watchdog or can carry out tests and diagnoses of differing complexity. Safe algorithms and self-monitoring measures of a safety function unit 32 can thereby at least be partly replaced or complemented. For this purpose, the diagnostic unit 34 has expectations for the output of the safety function unit 32 at specific times, either in its regular operation or in response to specific artificial sensor information fed in as a test. A diagnostic unit 34 is preferably used that does not test individual safety function units 32 or does not expect a specific evaluation result from them, even this is possible in a complementary manner, but that rather carries out a system diagnosis of the safety function modules 32 involved in the safeguarding of the machine 12, as will be explained below with reference to FIGS. 5 to 7.

An automation unit 36 is a logic unit 28 for non-safety related automation work that monitors sensors 14 and machines 12 or parts thereof, generally actuators, and that controls (partial) routines on the basis of this information or provides information thereon. An automation unit 36 is in principle treated by the performance environment like every logic unit 28 and is thus preferably likewise containerized. Examples for automation work include a quality check, variant control, object recognition for picking, sorting, or for other processing steps, classifications, and the like. The delineation from the safety related logic units 28, that is from a safety function unit 32 or diagnostic units 34, consists of an automation unit 36 not contributing to accident prevention, i.e. to the technical safety application. A reliable working and a certain monitoring by the performance environment 22 is desired, but this serves an increase of the availability and thus of the productivity and quality, but not of the safety. This reliability can naturally also be established by monitoring an automation unit 36 as carefully as a safety function unit 32 so that it is possible, but not absolutely necessary.

It becomes possible by the use of the performance environment 22 to deploy logic units 28 for a safety application in practically any desired manner over an environment, also a very heterogeneous environment, of the hardware components 26, including an edge network or a cloud. The performance environment 22 takes care of all the required resources and conditions of the logic units 28. It invokes the required logic units 28, ends or moves them between the computing nodes 26 and the subnodes 30.

The architecture of the performance environment 22 additionally permits a seamless merging of safety and automation since safety related function units 32, diagnostic units 34, and automation units 36 can be performed in the same environment and practically simultaneously and can be treated in the same manner. In the event of a conflict, the performance environment 22 preferably gives priority to the safety function units 32 unit and the diagnostic units 34, for instance in the event of scarce resources. Performance rules for the coexistence of relevant logic units 28 of the three different types can be taken into account in the configuration file.

FIG. 4 shows a schematic representation of a performance environment 22 using Kubernetes by way of example. The performance environment 22 is called a control plane here. FIG. 4 is based on FIG. 3, with a computing node 26 having been omitted for reasons of clarity and now generic logic units 38 being shown as representative for all three possible types. The master 24 has a sub-structure in Kubernetes. The (Kubernetes) master 24 is still not itself responsible for the performance of containers or logic units 28, but rather takes care of the general routines or the orchestration (orchestration layer). The configuration file is accordingly called an orchestration file. A database etcd 40 for all the relevant data of the Kubernetes environment, an API server 24 as an interface to Kubernetes, and a scheduler and controller manager 44 that carries out the actual orchestration are furthermore present.

The hardware present is divided into nodes as computing nodes 26. There are in turn one or more so-called pods as sub-nodes 30 in the nodes and the container having the actual micro-services are therein, in this case the logic units 28 together with the associated container runtime and thus all the libraries and dependences required for the logic unit 28 on the runtime. A node management unit 38 now divided into two with a so-called Kubelet 38a and a proxy 38b performs the local management. The Kubelet 38a is an agent that manages the separate pods and containers of the node. The proxy 38b in turn contains the network rules for the communication between the nodes and with the master.

Kubernetes is a preferred, but by no means the only implementation option for the performance environment 22. Docker Swarm cold be named as one further alternative among many. Docker itself is not a direct alternative, but rather a tool for producing containers and thus combinable with Kubernetes and Docker Swarm that then orchestrate the containers.

FIG. 5 shows a further schematic representation of the performance environment 22 to illustrate a system diagnosis by a state monitoring and a performance monitoring. A system diagnostic unit 34 is responsible for this as a special embodiment of a diagnostic unit 34. Three logic units 28 that work in sequence to evaluate data of a sensor 14 are here purely by way of example for the monitoring. The invention is not restricted to this; there can be any desired number of logic units 28 in any desired mutual connection and with or without their own connection to a sensor 14. The logic units 28 are preferably safety function units 32. Further diagnostic units 34 can be provided that, for example, monitor or test specific safety function units in a dedicated manner supplementary to the system diagnosis. It is furthermore also possible to integrate automation unit 36 in the system diagnosis even if a safe monitoring for the hazard avoidance or accident avoidance would per se be required. It is not the specific design of the logic units 28 that is important in the following so that the generic logic units 28 are shown.

The system diagnosis unit 34 is responsible for a state monitoring 46 and a performance monitoring 48. A final assessment of the safe state of the total system can be derived therefrom. The state monitoring 47 will subsequently be explained in even more detail with reference to FIG. 6; the performance monitoring with reference to FIG. 7. A single system diagnostic unit 34 is shown in FIG. 5 with its own blocks for the state monitoring 46 and performance monitoring 48. It above all serves the understanding of the concept; it is equally conceivable to understand the state monitoring 46 and the performance monitoring as part of the system diagnostic unit 34 or to alternatively deploy the functionality in a different manner.

The logic units 28 communicate with the system diagnostic unit 34 over a message system or message transmission system. The message system is part of the performance environment 22 or is implemented as complementary thereto. There is a double message flow from the state messages or state messages 50 of the state monitoring 46 that provide information on the internal status of the sending logic unit 28 and performance messages 52 of the runtime monitoring 52 that provide information on service demands or service performances of the sending logic units 28. The message system is consequently provided in double form or is configured with two message channels. Each message 50, 52 preferably comprises metadata that safeguard the message flow. These metadata, for example, comprise transmitter information, a time stamp, sequence information, and/or a checksum on the message contents.

The system diagnosis unit 34 determines an overall status of the safety device 10 based on the obtained state messages 50 and correspondingly an overall statement on the processing of service demands or on a performance routine of the safety device 10 from the obtained performance messages 52. Faults in the safety device 10 are uncovered by a comparison with associated expectations and an appropriate safety related response is initiated in the event of a fault.

Every irregularity does not immediately mean a safety related fault. Deviations can thus be tolerated for a certain time in dependence on the safety level or repair mechanisms are attempted to return to a fault-free system status. However, the temporal and other framework in which only observation can be performed is exactly specified by the safety concept. There can furthermore be degrees of faults that require differently drastic safeguarding measures and evaluations of faults due to the situation. The latter results in a differentiated understanding of safety and safe that includes the current situation. The failure of a safety related component or the non-performance of a safety related functions can still not necessarily mean an unsafe system state under certain requirements, i.e. due to the situation. A sensor 14 could, for example, fail that monitors a collaboration zone with a robot while the robot definitely does not dwell in this zone, which can in turn be ensured by the robot's own safe coordinate bounding. Such situation related rules for the evaluation whether a safety related response has to take place must then, however, likewise be known to the system diagnostic unit 34 in a manner coordinated with the safety concept.

The safety related response of the machine 12 is preferably triggered by a shutdown service 54. It can be a further safety function unit 32 that can preferably be integrated in the system monitoring, contrary to the representation. The shutdown service 54 preferably works in an inverted manner, i.e. a positive signal is expected from the system diagnostic unit 34 and is forwarded to the machine 12 that the machine 12 may work. A failure of the system diagnostic unit 34 or of the shutdown service 54 is thus automatically contained.

Despite its name, the machine is not necessarily shut down by the shutdown service, this is only the most drastic measure. Depending on the fault, a safe state can already be achieved by a slowing down, a restriction of the speed and/or of the working space, or the like. This then has fewer effects on the productivity. The shutdown service 54 can also be required by one of the logic units 28 if a hazardous situation has been recognized there by evaluating the sensor data. A corresponding arrow was omitted for reasons of clarity in FIG. 5.

FIG. 6 shows a schematic representation of the state monitoring 46 based on the state messages 50. State messages 50 are preferably communicated continuously or regularly in that sensor to the system diagnostic unit 34 that a state message 50 has to arrive from every monitored logic unit 28 at the latest after a fixed time of, for example, some milliseconds. A fixed cycle or time cycle is conceivable here, but not required, time fluctuations within the frame of the fixed duration are therefore possible.

The logic units 28 preferably carry out a self diagnosis before the transmission of a state message 50. This is not necessarily done, a state message 50 can be just a sign of life or the forwarding of internal statuses without a previous self-diagnosis or the self-diagnosis is carried out less often than state messages 50 are transmitted. The self-diagnosis, for example, checks the data and the program elements, the processing results and the system time gored in its memory. The state messages 50 correspondingly contain information on the internal state of the logic unit 28 and provide information on whether the logic unit is able to perform its work correctly, for instance whether the logic unit 28 has all the required data available in a sufficient time. In addition, the state messages 50 preferably comprise the above-named metadata.

The system diagnostic unit 34 interprets the content of the state messages 50 and associates it with the respective logic units 28. The individual statuses of the logic units 28 are combined to form a total state of the safety device 10 from a safety point of view. The system diagnostic unit 34 has a predefined expectation as to which total state ensures the safety in which situation. If this comparison with the current total state shows that this expectation has not been met while possibly taking account of the already discussed tolerances and situation based adaptations, it is thus a safety related fault. A corresponding message is sent to the shutdown service 54 to set the machine 12 into a safe state appropriate for the fault.

FIG. 7 shows a schematic representation of the performance monitoring 48 based on the performance messages 52. The first logic unit 28 within a service generates an unambiguous program sequence characterization, in brief a sequence, that all the involved logic units 28 of a service reference in their performance. The sequence is propagated to the directly following logic units 28 after ending the respective performance so that it can be related thereto on the preparation of its performance message 52. A performance message 52 comprises, preferably in addition to the above-named metadata, a start time and a duration of the respective performance. Further possible components of a performance message report 52 are an unambiguous designation of what was carried out and of the sequence. Performance messages 52 are preferably sent on an event basis in each case after complete performance. Since sensor data that are cyclically available are frequently evaluated, an event-based message flow can indirectly also be cyclic or regular in the above-defined sense.

An aggregator 56 collects the performance messages 52 and changes the performances into a logical and temporal arrangement or into a runtime routine with reference to the unique program sequence characterization. The performance routine thus describes the actual performances. The system diagnostic unit 34, on the other hand, has access to a performance expectation 57, i.e. an expected performance routine. This performance expectation 58 is a specification that a safety expert has typically fixed in connection with the safety concept, but that can still be modified by the system diagnostic unit 34. If the system diagnostic unit 34 should have no access to the performance expectation 58, it is at least a safety related fault, at least after a time tolerance, with the consequence that the shutdown service 54 is requested to safeguard the machine 12. The aggregator 56 and the performance expectation 58 are shown separately and are preferably implemented in this manner, but can alternatively be understood as part of the system diagnostic unit 34.

The system diagnostic unit 34 now compares the performance routine communicated by the aggregator 56 with the performance expectation 58 within the framework of the performance monitoring 48 to recognize temporal and logical faults in the processing of a service demand. On irregularities, steps for stabilization can be initiated or the machine is safeguarded via the shutdown service 54 as soon as a fault can no longer be unambiguously controlled.

Some examples for checked aspects of the performance monitoring 48 are: There is no runtime to completely work through a service; an unexpected additional runtime was reported, either an unexpected multiple performance of a logic unit 28 involved in the service or a performance of a logic unit 28 not involved in the service; a performance time is too short or too long and indeed together with the quantification for the evaluation whether it is serious; the time elapsed between performances of individual performances of a logic unit 28. Which of these irregularities are safety related, in which framework and in which situation they can still be tolerated, and which appropriate safeguarding measures are initiated is stored in the performance expectation 58 or in the system diagnostic unit 34.

FIG. 8 shows a comparative illustration of the safety engineering monitoring in the virtual world and the real world. Up to now, safety monitoring in the real world 60 has been described with reference to FIGS. 1 to 7, as now summarized in a simple symbol on the right side in FIG. 8. At least one real machine 12 is here monitored using real sensor data of at least one real sensor 14. This is preferably done in the particularly flexible described manner using containers and their orchestration and an advantageous state and performance monitoring.

A simulation, virtualization, or virtual world 62 is likewise shown summarized in a simple symbol on the left side. A simulation of the real world 60 using at least one simulation environment is meant by this of which some were introduced in the introduction. The simulation comprises a machine model of the machine 12 and a sensor model of the sensor 14; there is therefore a digital twin with respect to the machine 12 and a digital twin with respect to the sensor 14. The degree of detail to which the machine 12 and its machine movements or the sensor 14 and corresponding synthetic sensor data are simulated in the simulation depends on the embodiment. A sensible measure is that the gap between reality and virtualization does not introduce any safety related distortion. In the practical implementation of the virtualization, the concepts can be fully or partly taken over from the real world 60, analogously to the descriptions with reference to FIGS. 1 to 7. The synthetic sensor data can therefore be evaluated and the safety functions that perform it can be containerized and the containers can in turn be orchestrated. It must be noted that the term safety function is not fully identical with that of a (safety related) logic unit 28. In the virtual world 62, a container having a robot simulation or another machine simulation or with a sensor simulation is also considered as a safety function in addition to possible virtual counterparts of the logic units 28 since safety related errors likewise have to be responded to in such simulations. A safe virtualization is thus produced overall on the left side of the virtual world 62.

Messages are exchanged between the safety monitoring of the real world 60 and the virtual world 62 in the overlap zone 64 in the middle of FIG. 8, for example via a cloud, also a private cloud. This also serves the synchronization between the preferably safely orchestrated real world 60 and the likewise preferably safely orchestrated virtual world 62. A diverse, two-channel system is thereby formed. Processes, evaluation results, and the like from the real world 60 and the virtual world 62 can be compared with one another with respect to the run time.

FIG. 9 shows a representation of a virtualization of at least one machine 12 monitored by at least one sensor 14 with a monolithic implementation of functions #1 . . . #5 functions in respective simulation environments 66, abbreviated to SU #1 . . . . SU #3. The functions #1 . . . #5 observed here are safety functions, that is relevant to the safe monitoring. This can be understood in the sense of a logic unit 28 for evaluation of (synthetic) sensor data or of a diagnosis, but also in an extended sense of a simulation of a machine 12 or of a sensor 14 since a defective digital twin likewise has safety relevance. There can additionally be further functions that are embedded in a simulation environment in a similar or different manner, but are not relevant to safety and which will therefore not be looked at any further.

ROS, Unity, and Omniverse can be used as simulation environments 66 by way of example. It was explained for this example in the introduction that different simulation environments 66 may be required to bundle respective advantages depending on the safety function. One example is the use of ROS for the integration of older hardware, but of Unity for a visualization of the environment. In the implementation in accordance with FIG. 9, the simulation environments 66 are monolithic structures within which the complex interplay of the safety functions and the functions of the simulation environment used thereby remains transparent to external. This then leads to great difficulties in monitoring or testing the virtualization pipeline and thus in making the virtualization visible. In addition, the simulation environments 66 typically contain numerous functions that are not even used by the safety functions and that therefore unnecessarily take up resources (“software bloat”).

The communication is also complex and accessible to a safe monitoring with difficulty. This relates to communication to external, for example to the machine 12, to a classical controller, or to infrastructure sensors. Separate interfaces 68 or additional packets are then required for this to, for example, be able to communicate over protocols such as Profibus or MQTT (message queuing telemetry transport). Similar can apply to inputs of, for example, a machine controller or a machine visualization. Communication to internal of the simulation environments 66 between one another is only possible through further interfaces 70 that only form a very specific peer-to-peer bridge, for example between ROS and Unity or between Unity and Omniverse. Such interfaces 70 are not even absolutely available, at least not for more recent simulation environments or newer versions thereof.

The monolithic safe virtualization in accordance with FIG. 9 is not covered by the protected scope of the claims. It has serious disadvantages whose overcoming in accordance with the invention by atomization in containerized modules and their orchestration will now be explained with reference to FIG. 10. It must, however, be stated that there was previously no safe virtualization at all in the prior art, not even with monolithic approaches as in FIG. 9.

FIG. 10 shows a representation of a safe virtualization in which the safety functions are now atomized with the aid of containers. This means that a suitable simulation environment 66 is still localized for every safety function. The safety function is then packed into a container together with all the functions and dependencies of the selected safety function required by the safety function. Atomized safety functions 72 are thereby produced that are respectively shown in FIG. 10 as a pair of the function #1 . . . #5 and the associated simulation environment SU #1 . . . . SU #3. An atomized safety function 72 is thus a container that contains both the actual safety function and the simulation environment 66 required for it, the latter, however, preferably slimmed down, namely only to the required extent. The unused functions of FIG. 9 (software bloat) can be dispensed with.

The required functionality is additionally preferably added to the containers of the atomized safety functions 72 to take part in a stateful communication 74, that is to be able to exchange messages with other atomized safety functions 72 or with the outside world. This functionality also remains slimmed down and is adapted to the safety function of the container and its communication requirements. The container can therefore, for example, use the Profibus or MQTT protocol precisely when the safety function requires it. Examples of a suitable stateful communication 74 such as Apache Kafka have been named in the introduction. The required functionality is furthermore preferably added to the containers to enable their monitoring using a mechanism described with respect to FIGS. 5 to 7 or using a different mechanism, for instance by software such as Prometheus. The corresponding diagnostic unit 76 is only drawn schematically and can possibly participate in the stateful communication 74 differing from the representation.

The atomized safety functions 72 of the virtual world 62 are preferably integrated in an orchestration, for example, by means of Kubernetes, as described with reference to FIGS. 1 to 4 for the real world 60, preferably including a diagnosis and a monitoring by means of state and performance messages as described with reference to FIGS. 5 to 7.

A great advantage of the solution in accordance with the invention is its scalability. Large industrial plant or logistics centers having hundreds or even more vehicles, robots, or other machines and a corresponding number of sensors can also easily be monitored and virtualized. Smaller applications such as a single robot arm that is monitored by a single sensor or by a few sensors are equally possible. This scalability is, on the one hand, due to the tools used, namely containers and their orchestration, and the mechanisms for achieving functional safety, in particular in accordance with the explanations on FIGS. 1 to 7. However, this can only be really utilized in the virtual world 62 in the uniform implementation with atomized safety functions 72 and preferably with an equally uniform stateful communication 74 used together in accordance with FIG. 10. The complexity is here reduced to what the atomized safety functions 72 actually require and this remaining complexity is moreover encapsulated in the containers. The disadvantages of a monolithic implementation with interfaces 68, 70 to be manually individually adapted or even still to be developed thus no longer occur. The unification in particular makes it possible to restart, to replicate if necessary, individual components and safety functions in the case of errors, to manage with practically any desired heterogeneous hardware landscapes, and to deploy the computing load suitably there, and to unify the communication, and in this respect nevertheless to provide a required protocol such as Profibus, MQTT, ROS, HTTP, and the like in the individual case in one of the atomized safety functions 72.

1. A method of safeguarding at least one machine that is monitored by at least one sensor that generates sensor data with respect to the machine, wherein
movements of a machine model of the machine are carried out in a simulation and synthetic sensor data of a sensor model of the sensor are generated, and
wherein a plurality of safety functions are performed in the simulation in which an evaluation is made by a safety related evaluation of the simulation whether a hazardous situation is present to output a safety signal to the machine to trigger a safety response in the case of a hazardous situation,
wherein the safety functions are each individually implemented per se in a container for this purpose.

2. The method in accordance with claim 1,
wherein the safety signal is output when a hazardous situation is recognized in the simulation.

3. The method in accordance with claim 1,
wherein the sensor data of the sensor are evaluated by at least one real safety function, and wherein the safety signal is output when a safety function of the simulation and the real safety function produce inconsistent results.

4. The method in accordance with claim 1,
wherein a simulation environment is implemented by the respective safety function, in its container.

5. The method in accordance with claim 1,
wherein the safety functions are performed in a respective one of a plurality of different simulation environments.

6. The method in accordance with claim 1,
wherein the safety functions communicate with one another over a stateful message system.

7. The method in accordance with claim 6,
wherein the functions for communication over the stateful communication system are implemented by the respective safety function in its container.

8. The method in accordance with claim 1,
wherein the containers with the safety functions are managed in a performance environment with at least one computing node by a container orchestration system.

9. The method in accordance with claim 8,
wherein the performance environment is implemented on at least one sensor, a programmable logic controller, a machine controller, a processor device in a local network, an edge device, and/or in a cloud.

10. The method in accordance with claim 1,
wherein at least one containerized diagnostic function monitors the safety functions, and wherein the safety function transmits state messages and
performance messages to the diagnostic function for this purpose and the diagnostic function recognizes a safety related malfunction using states from the state messages in a state monitoring and using a performance routine from the performance messages in a performance monitoring.

11. The method in accordance with claim 1,
wherein the at least one sensor is configured as an optoelectronic sensor, as an ultrasound sensor, inertia sensor, capacitive sensor, magnetic sensor, inductive sensor, UWB sensor, or as a process parameter sensor

12. The method in accordance with claim 11,
wherein a plurality of the same or different sensors are provided.

13. The method in accordance with claim 11,
wherein the optoelectronic sensor is one of a light barrier, light scanner, light grid, laser scanner, FMCW LIDAR, and a camera.

14. The method in accordance with claim 11,
wherein the process parameter sensor is one of a temperature sensor, throughflow sensor, filling level sensor, and a pressure sensor.

15. A safety device for monitoring at least one machine, wherein the safety device has at least one sensor for generating sensor data with respect to the machine and a processing unit that is connected at least indirectly to the machine and in which a method of safeguarding at least one machine runs, with the at least one being monitored by at least one sensor that generates sensor data with respect to the machine, wherein movements of a machine model of the machine are carried out in a simulation and synthetic sensor data of a sensor model of the sensor are generated, and wherein a plurality of safety functions are performed in the simulation in which an evaluation is made by a safety related evaluation of the simulation whether a hazardous situation is present to output a safety signal to the machine to trigger a safety response in the case of a hazardous situation, wherein the safety functions are each individually implemented per se in a container for this purpose.
